(19) United States
(12) Patent Application Publication
(10) Pub. No.: US 2008/0129694 A1
(43) Pub. Date: Jun. 5, 2008

(54) Keyless user interface device

(75) Inventor: G. Neil Haven, Kooskia, ID (US)

Correspondence Address: G NEIL HAVEN, HC 66 BOX 246-C, KOOSKIA, ID, 83539, US

(73) Assignee: Liberty Reach Inc., Kooskia, ID (US)

(21) Appl. No.: 11/879,612

(22) Filed: Jul. 19, 2007

Related U.S. Application Data
(60) Provisional application No. 60/867,962, filed on Nov. 30, 2006.

(51) Int. Cl. G06F 3/00

(52) U.S. Cl. 345/158

(57) ABSTRACT

The present invention provides a method and apparatus used to create computer input. The apparatus includes a wearable glove constituted to sense the motions of the wearer's wrist and finger joints. Information regarding the motion of the wearer's joints is transmitted to a computer program which uses the method of the invention to interpret said motion as computer input such as might otherwise be provided by a computer keyboard and/or a computer mouse input device.

### CROSS-REFERENCE TO RELATED APPLICATIONS

This application claims the benefit of co-pending U.S. Provisional Application Ser. No. 60/867,962 filed 30 Nov. 2006.

### STATEMENT REGARDING FEDERALLY SPONSORED RESEARCH

Not applicable.

### REFERENCE TO SUPPLEMENTARY MATERIALS ON COMPACT DISC

Not applicable.

### BACKGROUND OF THE INVENTION

This invention relates generally to the field of computer input devices, and more particularly to devices for transforming kinetic motions of the hands and wrists into symbols or control signals for use by a computer. Commonly recognized devices for performing these transformations include computer keyboards and computer mouse input devices.

### DESCRIPTION OF THE RELATED ART

A computer keyboard is a computer input device which provides a computer with a stream of discrete or superposed symbols. Depending on the computer program in operation to interpret the stream of symbols, these symbols may be treated as information to be stored for later retrieval or as commands to control the operation of the computer. Examples of the former treatment include typing a paragraph of English into a word-processing program; examples of the later treatment include typing the superposition of Control-Alt-Delete at the prompt of a computer running the MS-DOS operating system.

A computer mouse is used as a computer input device to control the location of a cursor on a video display connected to the computer. Information describing the movement of the mouse across a surface, or within a sensor volume, is provided to the computer where it is transformed into a corresponding cursor movement. In addition, there are typically two or three buttons on the mouse for providing discrete input.

Computer keyboards and mice provide a computer interface via motions of a user's hands and wrists, but a variety of alternative methods for providing computer input are known in the prior art which use, inter alia, motions of the mouth and tongue (“Mouth mounted input device” U.S. Pat. No. 7,071,844), the nose (“Method for video-based nose location tracking and hands-free computer input devices based thereon” U.S. Pat. No. 6,925,122), heart rate, temperature, general somatic activity and galvanic skin response (“Computer input device with biosensors for sensing user emotions” U.S. Pat. No. 6,190,314), the vocal tract (“Input device for computer speech recognition system” U.S. Pat. No. 4,461,024), the eye (“Eye tracking apparatus and method employing grayscale threshold values” U.S. Pat. No. 5,481,622), and so on.

Body-wearable devices, and glove-based devices in particular, for human-computer interaction are known to the prior art:

U.S. Pat. No. 3,022,878 to R. Seibel, of Feb. 27, 1962 discloses a data input device comprising a glove-like casing having a plurality of multi-position switches. The switches are set by the user's phalanges to various character representing positions in order to transmit data to an associated machine. This bulky device was designed for special purpose applications such as airplane cockpits and has proved to offer little of the functionality needed in more modern computer interfaces.

U.S. Pat. No. 4,414,537, filed Sep. 15, 1981, by G. Grimes and entitled “Digital Data Entry Glove Interface,” describes a glove-based input device. The Grimes patent discloses a glove with sensors for detecting the flexing of finger joints, sensors for detecting contact between various portions of the hand, and sensors for detecting the orientation of the hand. The Grimes device is used to identify static hand positions representing the characters of the alphabet. Although the Grimes device represents an advance over prior devices in terms of its reliability and streamlined form, it was designed particularly to process a single set of gestures called the Single Hand Manual Alphabet for the deaf and, given its limited programmability and set of fixed binary-response sensors, it is incapable of adaptation to different character sets or reprogramming to accommodate the desires of individual users. As such, it is not in general use today.

U.S. Pat. No. 4,988,981 for a computer data entry and manipulation apparatus and method by Thomas G. Zimmerman and Jaron Z. Lanier, patented Jan. 29, 1991, describes an “Apparatus . . . for generating control signals for the manipulation of virtual objects in a computer system according to the gestures and positions of an operator's hand or other body part.” This apparatus has a fixed vocabulary of gestures intended for use in controlling a cursor and manipulating virtual objects; as such it does not provide discrete alphanumeric input.

Although alternative methods of computer input such as described in the aforementioned U.S. Patents have found application in certain niches, the combination of computer keyboard and computer mouse remains the most common method used for human-computer interaction. However, this combination of two fundamentally different interface devices imposes an inefficiency on the user when the user must switch from one hand configuration to operate the traditional keyboard into another hand configuration to operate the mouse.

Portable computers are commonly sold equipped with a touch-pad (for a recent example of advances in this technology, see US Pat Appl #20060044259) and a traditional keyboard mounted together. The proximity of the two input devices alleviates the inefficiencies involved in switching between the interface devices to some extent, but some find these devices awkward to use and difficult to master.

Moreover, as discussed by Holzrichter et al. in U.S. Pat. Appl 20020033803 an important issue afflicting mouse-type user interface devices is that the design of these devices causes repetitive motion injury to many users. These injuries appear to occur because the mouse-motion on a plane and the location of the attached buttons is incompatible with natural hand-wrist-finger motions.

One solution to these problems is to integrate the functions of a computer mouse with the user's hand in a wearable glove. A recent attempt to do this is described in U.S. Pat. Nos. 5,444,462, and 6,097,369 issued to Wambach on Aug. 22, 1995 and Aug. 1, 2000, respectively. Wambach describes a glove to be worn on a user's hand wherein the glove includes micro-switches mounted next to a joint of the index finger and on opposite sides of the wrist.

Another recent and related invention is described in U.S. Pat. No. 6,154,199 issued to Butler on Nov. 28, 2000. Butler describes a hand positioned mouse which includes a glove having a trackball supported in a housing attached to the side of the index finger so that the trackball can be operated by the thumb.

Another recent glove-type user interface device is described in U.S. Pat. No. 7,057,604 issued to Bajramovic. Bajramovic describes a computer mouse on a wearable glove, which includes a tracking device for controlling cursor movement on a video display and one or more switches for controlling mouse “click” functions. The user of this device may type on a keyboard with all fingers while wearing the glove.

The inventions disclosed in U.S. Pat. Nos. 5,444,462, and 6,097,369 and 6,154,199 and 7,057,604 mitigate some of the ergonomic difficulties afflicting users of keyboard/mouse user interfaces; however, since they only address the design of the mouse interface without addressing the design of the keyboard interface, they do not represent a truly integrated keyboard/mouse solution. What is needed is a principled integration of keyboard and mouse functionalities within a low-cost, ergonomically sound design. The present invention provides a method and apparatus for achieving this integration. Moreover, the method and apparatus of the present invention adds a capability to human-computer interaction without precedent in the prior art: that of user-adaptability. In one of its embodiments the present invention is flexible enough to learn the preferences and habits of its users so that, over time, the performance of the interface will improve.

### REFERENCES: U.S. PATENT DOCUMENTS

| U.S. Patent Number | Date | Inventor |
|---|---|---|
| 3,022,878 | Feb. 27, 1962 | Seibel |
| 4,414,537 | Nov. 8, 1983 | Grimes |
| 4,461,024 | Jul. 17, 1984 | Rengger, et al. |
| 4,988,981 | Jan. 29, 1991 | Zimmerman, et al. |
| 5,414,256 | May 9, 1995 | Gurner, et al. |
| 5,444,462 | Aug. 22, 1995 | Wambach |
| 5,481,622 | Jan. 2, 1996 | Gerhardt, et al. |
| 5,510,800 | Apr. 23, 1996 | McEwan |
| 5,661,490 | Aug. 26, 1997 | McEwan |
| 6,097,369 | Aug. 1, 2000 | Wambach |
| 6,154,199 | Nov. 28, 2000 | Butler |
| 6,190,314 | Feb. 20, 2001 | Ark, et al. |
| 6,925,122 | Aug. 2, 2005 | Gorodnichy |
| 7,057,604 | Jun. 6, 2006 | Bajramovic |
| 7,071,844 | Jul. 4, 2006 | Moise |
| 20020033803 | Mar. 21, 2002 | Holzrichter, et al. |
| 20060044259 | Mar. 2, 2006 | Hotelling, et al. |

### REFERENCES: OTHER DOCUMENT

1] R. Murray-Smith (1998), Modelling Human Control Behaviour with Context-Dependent Markov-Switching Multiple Models, IFAC Man-Machine Systems Conf., Kyoto, Japan
2] R. Murray-Smith, Modelling Human Gestures and control behaviour from measured data, IFAC conference on Artificial Intelligence in Real Time Control, Budapest 2000
3] Port, Robert and Timothy van Gelder (eds.). 1995. Mind as motion: Explorations in the dynamics of cognition. Bradford books, MIT Press.
4] Saltzman, E. L., & Munhall, K. G. (1989) A dynamical approach to gestural patterning in speech production. Ecological Psychology, 1, 333-382.
5] Saltzman, E. (1995). Dynamics and coordinate systems in skilled sensorimotor activity. In Port, R. and Van Gelder, T. (Eds.), Mind as motion. Cambridge, Mass.: MIT Press
6] S. Strachan, R. Murray-Smith, I. Oakley, J. Ängeslevä, Dynamic Primitives for Gestural Interaction, Mobile Human-Computer Interaction—MobileHCI 2004: 6th International Symposium, Glasgow, UK, Sep. 13-16, 2004. Proceedings. Stephen Brewster, Mark Dunlop (Eds), LNCS 3160, Springer-Verlag, p 325-330, 2004.
7] Vijayakumar, S. and Schaal, S., Locally Weighted Projection Regression: An O(n) Algorithm for Incremental Real Time Learning in High Dimension Space, Proc. of Seventeenth International Conference on Machine Learning (ICML2000), pp. 1079-1086 (2000)

### BRIEF SUMMARY OF THE INVENTION

The present invention provides a glove-type computer user interface which performs all the functions of a computer keyboard and a computer mouse or touch-pad.

The invention can be characterized as an apparatus and set of methods, as implemented in a set of computer programs, for translating gestures made by a user's hands and wrists into computer-readable symbols and commands. The apparatus is comprised of a pair of light-weight gloves into which a plurality of sensors is embedded. Information gathered by the sensors representing the position, speed, and acceleration of the joints of the hand and wrist is transmitted to a computer by means of additional electronic apparatus. Using a gestural dynamical model, the computer implements methods to interpret such information in terms of gestures the user is trying to execute. These gestures are then mapped, in a user-definable fashion, onto some set of symbols and commands.

In an optional embodiment of this invention, the gestural dynamical model used to detect symbols and commands within the data stream can be made self-modifying so that the model evolves according to the user's dynamical habits. For instance, if a user habitually types a firm ‘y’ with the index finger of the right hand, but tends to type a gentle ‘j’ with the same finger, the dynamical model may use this firm/gentle distinction as a distinguishing characteristic between ‘y’ and ‘j’ for the user, even in the case that the user does not tend to make a spatial distinction between the two letters. Such a capability is not available in a traditional, fixed-position keyboard.

In yet another optional embodiment of this invention, the gestural dynamical model used to detect symbols and commands within the data stream can be made self-modifying so that the model uses historical and contextual information gathered by observation of a user's gestural habits to disambiguate otherwise ambiguous gestures. For instance, a user may tend to have a different hand position for an ‘h’ when preceded by a ‘t’ than when preceded by a ‘c’.

Some distinctions between this invention and a conventional keyboard are that:
Unlike a conventional qwerty keyboard, each user may choose for him or herself the most convenient mapping between gestures and keys. This includes the capability to omit mappings for entire fingers or hands if these appendages are missing;
Mouse-like functionality is evoked by the same types of gestures which evoke standard alphanumeric symbols without requiring the user to shift hand positions to a separate computer-mouse input device;
The interface device can adapt itself to individual user dynamical preferences over time so that the interface and the user can evolve together to find an optimal configuration of the interface device.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of some specific embodiments, serve to explain the principles of the invention by way of example without foreclosing such modifications and variations as would be apparent to a person skilled in the relevant arts.

FIG. 1 illustrates a wearable glove together with embedded sensors for sensing the dynamic state of a user's hands and wrists;

FIG. 2 illustrates an embodiment of the present invention in which information describing the dynamical state of a user's hands and wrists is gathered by a wearable glove, transmitted via a wireless transmitter to a receiver and thence to a host computer;

FIG. 3 is a flowchart of the method embodied in the computer software of the present invention;

FIG. 4 is a flowchart as in FIG. 3 illustrating a feedback connection which allows the present invention to adapt itself to a user's habits and preferences.

### DETAILED DESCRIPTION OF THE INVENTION

In the following description, numerous specific details are set forth such as examples of specific components, processes, algorithms, etc. in order to provide a thorough understanding of the present invention. It will be apparent, however, to one skilled in the art that these specific details need not be employed to practice the present invention. In other instances, well known components or methods have not been described in detail in order to avoid unnecessarily obscuring the present invention.

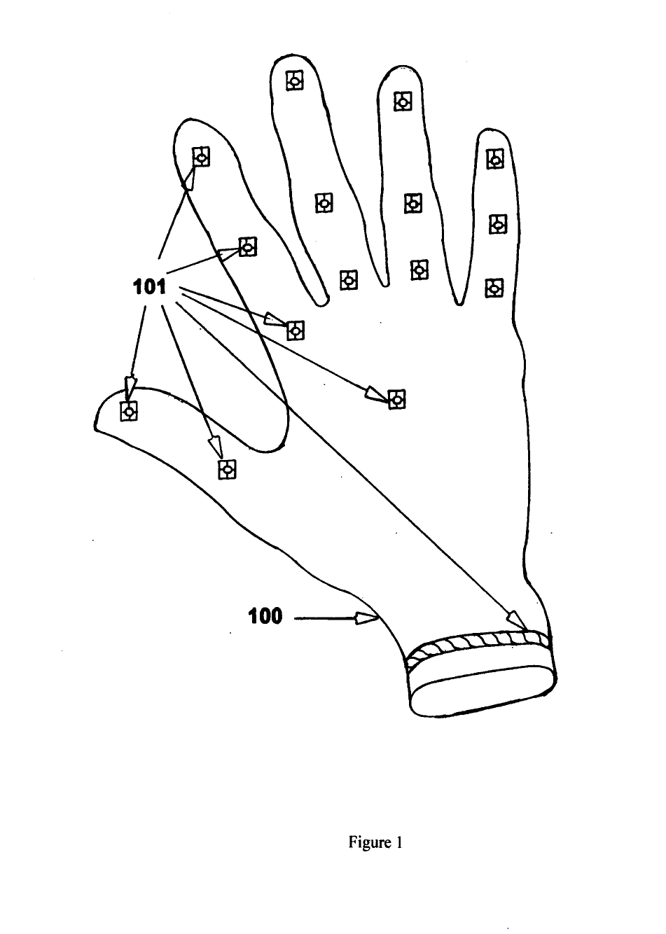

FIG. 1 illustrates a wearable glove 100 into which a plurality of sensors 101 are embedded. The sensors serve to measure quantities dependent upon the position, speed, and acceleration at a plurality of representative locations on the user's hand and wrist. The information from said measurements at a given time is the dynamic state of the wearable glove 100.

A collection of successive dynamic states measured while a user is performing an action intended to evoke a symbol or computer command is a gesture. The treatment of gestures as a collection of states or trajectory within a dynamical state space is termed gestural dynamics. For further discussion see Other References 2-6.

In a preferred embodiment the sensors 101 are flexible polymer piezoelectric accelerometers and strain gauges available from MSI Sensors of Hampton, Va.

In an alternative embodiment the wearable glove 100 is located within an ultrasonic or electromagnetic field (for example, the devices of U.S. Pat. Nos. 5,414,256 or 5,510,800 or 5,661,490). The plurality of sensors 101 is replaced by a plurality of passive or active means in a manner apparent to persons versed in the art which interact with said field to enable the measurement of the dynamical state of the wearable glove 100 from analysis of the ultrasonic or electromagnetic field.

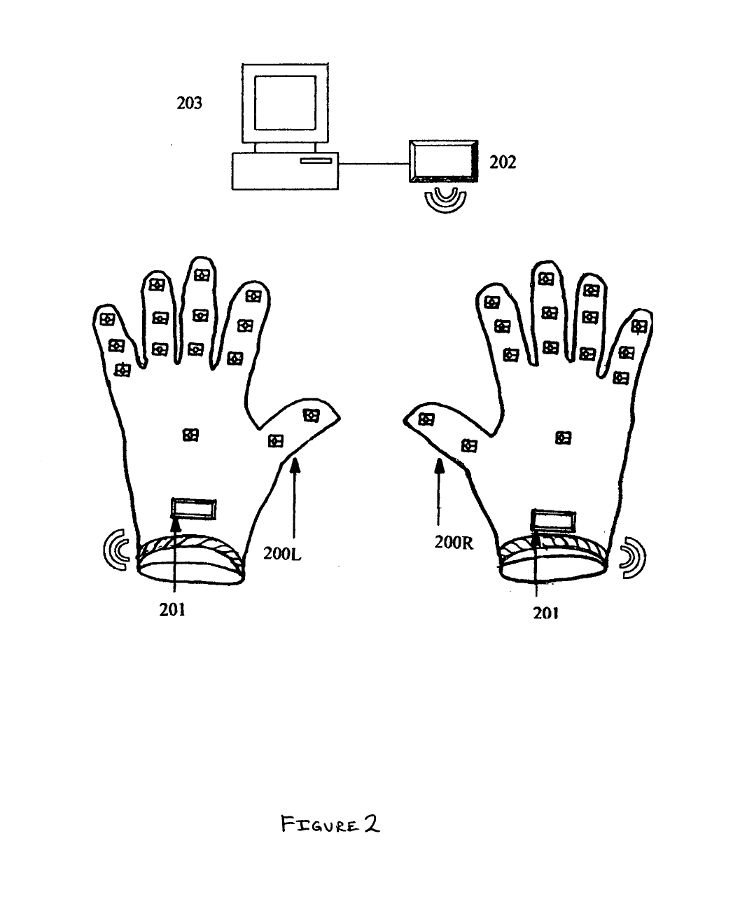

FIG. 2 illustrates a preferred embodiment of the present invention in which the information describing the dynamical state of a pair of the wearable gloves 200L and 200R is transmitted via a wireless transmitter 201 to a wireless receiver 202 and thence to a host computer 203.

In an alternative embodiment the wireless receiver 202 and wireless transmitter 203 are replaced by a direct physical wired connection from the wearable gloves 200L and 200R to the host computer 203.

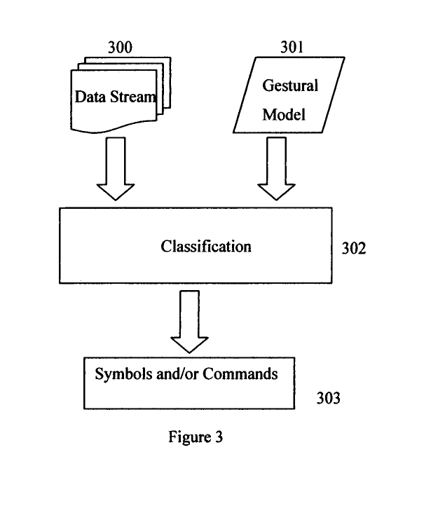

As shown in the flowchart of FIG. 3, the method of the present invention is to use a classification algorithm 302 to classify portions of the data stream 300 representing the time-varying dynamical state of said wearable gloves by reference to a gestural model 301. A variety of gestural models 301 and classification algorithms 302 will suggest themselves to those versed in the art (for examples of such models, see Other References 1 and 6), but in a preferred embodiment the classification algorithm 302 and the gestural model 301 are merged into a dynamical neural net. At a data-dependent rate, the classification stage 302 will produce a stream of symbols or computer commands 303 for use by the host computer 203.

It is an advantage of the present invention that the gestural model 301 can be a standardized gestural model (such as might be obtained from the gestures involved in typing on a traditional qwerty keyboard) or it can be modified as needed by the user. In particular, although the illustration in FIG. 2 shows a pair of wearable gloves 200L and 200R, each with five fingers, there is no requirement in the present invention that the wearer have five fingers on each hand, or even that the wearer have use of two hands. Since the mapping between gestures and symbols or commands can be completely arbitrary, the user of the present invention may create whatever mapping is convenient between the gestures he or she finds it convenient to make and a set of desirable symbols or commands.

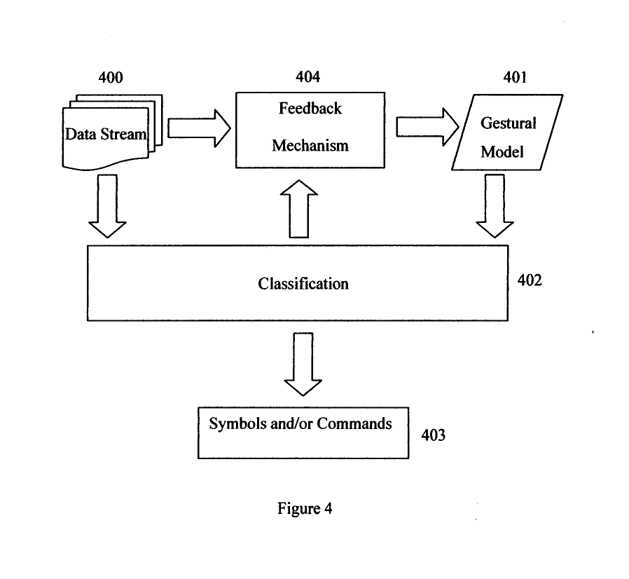

This flexible nature is further exploited in an alternative embodiment of the method of the present invention as illustrated in FIG. 4. This flowchart is derived from the flowchart of FIG. 3 via the addition of a feedback process 404 which uses the result of the classification algorithm 402 coupled with dynamical state information 400 to modify the gestural model 401. Said feedback mechanism 404 can be used to monitor the historical and contextual dynamical regularities of a particular user (or any aggregate of computer users) in order to modify the gestural model 401 so that said gestural model optimally coincides with the preferences and habits of said user(s).

Any number of embodiments of the feedback mechanism 404 may suggest themselves to persons skilled in the art. One such embodiment uses a technique suggested in Other References 7.

Said feedback mechanism 404 is an advantage of the present invention over current art in that a gestural model 401 adapted via said feedback mechanism enables the present invention to improve its functionality with time in terms of ease of use, speed of human-computer interaction, and ergonomic comfort.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A human-computer interface for transforming between gestures performed by the hand and wrist of a computer user and a stream of symbols for further interpretation by a computer program, said interface comprising:
an apparatus for sensing quantities dependent upon the linear and rotational position and/or speed and/or acceleration of some subset of the joints of said user's hands and wrists, said apparatus adapted to receive the hand of said computer user; and,
a further apparatus, either wired or wireless, for transmitting an analog or digital representation of the state of the hands and wrists; and,
a further apparatus, either wired or wireless, for receiving said analog or digital transmissions and making them available as a stream of digital information to a computational device; and,
a method, implemented as a computer program, for analyzing said digital information in order to extract from it a stream of symbols and/or computer commands, said symbols and/or computer commands chosen from, but not limited to, characters found on keyboards in arbitrary languages, punctuation and diacritical characters, escape and control characters, mouse movement commands, and mouse clicks.

2. The interface of claim 1 in which said apparatus for sensing quantities dependent upon the linear and rotational position, speed, and acceleration of some subset of the joints of said user's hands and wrists includes piezoelectric sensors which function as accelerometers and/or tension gauges.

3. The interface of claim 1 in which said apparatus for sensing quantities dependent upon the linear and rotational position, speed, and acceleration of some subset of the joints of said user's hands and wrists includes means for the production and analysis of an electromagnetic field with which said user's hand interacts.

4. The interface of claim 1 in which said apparatus for sensing quantities dependent upon the linear and rotational position, speed, and acceleration of some subset of the joints of said user's hands and wrists includes means for the production and analysis of an ultrasonic field with which said user's hand interacts.

5. The interface of claim 1 in which said method, implemented as a computer program, includes the further ability to modify its signal processing means according to the historical and contextual patterns of use by any particular computer user or any aggregate of computer users.

6. The interface of claim 2 in which said method, implemented as a computer program, includes the further ability to modify its signal processing means according to the historical and contextual patterns of use by any particular computer user or any aggregate of computer users.

7. The interface of claim 3 in which said method, implemented as a computer program, includes the further ability to modify its signal processing means according to the historical and contextual patterns of use by any particular computer user or any aggregate of computer users.

8. The interface of claim 4 in which said method, implemented as a computer program, includes the further ability to modify its signal processing means according to the historical and contextual patterns of use by any particular computer user or any aggregate of computer users.

9. The interface of claim 5 in which said modifications of signal processing means can be stored on digital media, retrieved, and transported between computer systems in order to customize the operation of the human-computer interface for use by a particular user.

10. The interface of claim 6 in which said modifications of signal processing means can be stored on digital media, retrieved, and transported between computer systems in order to customize the operation of the human-computer interface for use by a particular user.

11. The interface of claim 7 in which said modifications of signal processing means can be stored on digital media, retrieved, and transported between computer systems in order to customize the operation of the human-computer interface for use by a particular user.

12. The interface of claim 8 in which said modifications of signal processing means can be stored on digital media, retrieved, and transported between computer systems in order to customize the operation of the human-computer interface for use by a particular user.
